(19) United States
(12) Patent Application Publication
(10) Pub. No.: US 2004/0158548 A1
(43) Pub. Date: Aug. 12, 2004

(54) Method for dicretizing attributes of a database

(76) Inventor: Marc Boulle, Tregastel (FR)

Correspondence Address: Richard P Gilly, Wolf Block Schorr and Solis-Cohen, 22nd Floor, 1650 Arch Street, Philadelphia, PA, 19103-2097, US

(21) Appl. No.: 10/478,880

(22) PCT Filed: May 21, 2002
(86) PCT No.: PCT/FR02/01711

(30) Foreign Application Priority Data
May 23, 2001 (FR) 01/07006

(51) Int. Cl. G06F 7/00

(52) U.S. Cl. 707/1

(57) ABSTRACT

A discretization method for a database attribute containing a population of individuals, said attribute known as the source attribute, capable of assuming several modalities, the method characterized by an initial stage in which said source attribute modalities are regrouped into elementary groups, and a source and a target attribute contingency table is used to determine from among a set of elementary group pairs in a second stage the pair of elementary groups whose merger most extensively decreases the probability of independence of the source and the target attribute, and in a third stage the pair of elementary groups thus determined is merged, said second and third stages being iterative inasmuch as there is a pair of elementary groups allowing for said probability of independence to be decreased.

The present invention relates to a method for discretization of database attributes. In particular the present invention may be applied to the statistical handling of data, especially in the field of supervised learning.

Statistical data analysis, also known as ‘data mining,’ has undergone widespread development during recent years with the expansion of electronic business and the creation of vast databases. Generally speaking, data mining seeks to examine, classify and extract underlying patterns of relationships within a database, in particular being used to construct classification or prediction models. Within a database, classification allows for the identification of categories based on combinations of attributes, with the data then arranged as a function of these categories. For example, if the database pertains to the purchase of goods by consumers, such consumers may be placed in different categories, such as loyal customers, occasional customers, customers looking for items on sale, clients looking for high-quality goods, and so forth. Prediction, on the other hand, seeks to describe how one or more database attributes will behave in the future. Taking the purchase database just referred to as an example, it could prove interesting to predict the behavior of these consumers as a function of an increase or decrease in the price of one product or another.

One objective of data mining of the type known as “supervised” is to construct a prediction model aimed at producing a specific attribute. This construction involves searching among selected database attributes in order to identify one or more of them that exhibit the strongest statistical dependence on a target attribute, and to describe this dependence. For example, if consumers are classified on the basis of their total annual purchases under different consumption categories—heavy consumption, average consumption, light consumption—it would be interesting to determine which attributes of the purchase database are the most correlated (or to put it another way, the least statistically independent) to the attribute producing the consumption class. It will be noted that instead of the “consumption category” target attribute, one could go directly to the “total annual purchases” attribute.

Generally speaking, values, also known as “modalities,” assumed by an attribute may be numerical (e.g., total purchases) or symbolic (e.g. a consumption category), the former being labeled a numerical attribute and the latter a symbolic attribute.

Some supervised data mining methods require a “discretization” of numerical attributes. Discretization of a numerical attribute is understood to be a partitioning of the domain of values taken by an attribute in a finite number of intervals. If the domain in question is a range of continuous values, discretization involves quantifying this range. If such a domain already consists of ordered discrete values, discretization will serve to regroup these values in groups of consecutive values.

Discretization of numerical attributes has been addressed at length in literature. For example, one can find a description in work by Zighed et al. under the title “Induction Graphs” (Hermes Science Publications), wherein two types of discretization methods can be distinguished: descending and ascending. Descending methods stem from the total interval to be discretized, and seek the best interval cut-off point by optimizing a predetermined criterion. Ascending methods are based on elementary intervals and seek the best merger of two adjacent intervals by optimizing a predetermined criterion. In both cases, they are applied iteratively until one of the stoppage criteria is satisfied.

An ascending discretization method using the Π² criterion is referred to in literature as ChiMerge. By the same token, a descending discretization method using the Π² criterion is known as ChiSplit.

Before presenting the ChiMerge method, it should first of all be recalled that the Π² criterion allows for certain hypotheses for determining the degree of independence of two random variables, whereby S is a source attribute and T a target attribute. To establish the concept, let us suppose that S presents four modalities, a, b, c and d, and T three modalities, A, B and C. Table 1 is a contingency table for the variables S and T with the following conventions:

n_{y} is the number of individuals observed for the i^{th} modality of the variable S and the j^{th} modality of the variable T. n_{y} is also called the observed count for cell (i,j);

nᵢ is the total number of individuals for the i^{th} modality of the variable S. nᵢ is also called the observed count for row i;

nⱼ is the total number of individuals for the i^{th} modality of the variable T. nⱼ is also called the observed count for column j;

N is the total number of individuals.

TABLE 1

| S/T | A | B | C | Total |
|---|---|---|---|---|
| A | n₁₁ | n₁₂ | n₁₃ | n₁ |
| B | n₂₁ | n₂₂ | n₂₃ | n₂ |
| C | n₃₁ | n₃₂ | n₃₃ | n₃ |
| D | n₄₁ | n₄₂ | n₄₃ | n₄ |
| E | n₅₁ | n₅₂ | n₅₃ | n₅ |
| Total | n₁ | n₂ | n₃ | N |

Generally speaking, I and J are the number of modalities for attribute S and for attribute T, respectively.

The theoretical count e_{y} for cell (i,j) is defined by

$${e}_{y} = \frac{{n}_{i} {n}_{j}}{N} ,$$

where e_{y} represents the number of individuals that would be observed in the contingency table cell in the event of independent variables. The independence variance for variables S and T is measured by

$${x}^{2} = {\sum }_{i = 1}^{i} {\sum }_{j = 1}^{j} \frac{{( {n}_{y} {e}_{y} )}^{2}}{{e}_{y}} \qquad ( 1 )$$

The higher the value of Π², the less probable the hypothesis of independence for the random S and T variables. The probability of independence of variables is a misuse of language.

More specifically, Π² is a random variable whereby it can be shown that density follows a law going from Π² to (I−1), (J−1) degrees of freedom. The law of Π² is the one followed by a quadratic sum of normal centered random values. It in fact expresses a law y and tends toward a Gaussian law whenever the number of degrees of freedom is high.

For example, with J^{[illeg.]}5 and J^{[illeg.]}3, the number of degrees of freedom is 8. If the value of Π² calculated by equation (1) is 20, the law of Π² with 8 degrees of freedom gives a 1% probability of independence for S and T.

Herebelow we present the ChiMerge discretization method, wherein we pose the general case of a source attribute S with I modalities and an attribute T with J modalities. The ChiMerge method considers only two consecutive rows i and i+1 in the contingency table, that is to say, q′1, q′2 . . . q′j, the local distribution (i.e., within the local context of consecutive rows i and i+1) of modality probability for the target attribute T. If nᵢ is the count for row i and nᵢ+1 is the count for row i+1, the observed and theoretical counts for row i are expressed by n_{y}=aᵢnᵢ and e_{y}=q′nᵢ, respectively, where the aᵢ represent the proportions of counts observed for row i. By the same token, the observed and theoretical counts for row i+1 are expressed by n_{y}+1[illegible]=aᵢ+1[illegible]nᵢ+1 and eᵢ+1=q′ⱼnᵢ+1, respectively, where the aᵢ+1[illegible] represent the proportions of T modalities observed for row i+1. Local distribution of probability q′₁, q′₂ . . . q′j, of the target attribute modalities may be expressed by:

$${q}_{j}^{1} \frac{{a}_{y} {n}_{i} + {a}_{i + 1} {n}_{i + 1}}{{n}_{i} + {n}_{i + 1}} \qquad ( 2 )$$

According to the ChiMerge method, the value of Π² is calculated for rows i and i+1, in other words taking into account the fact that

$${\sum }_{j = 1}^{j} {q}_{j}^{1} = {\sum }_{j = 1}^{j} {a}_{y} = 1 \text{:}$$

$${x}_{ij + 1}^{2} = {n}_{i} ( {\sum }_{j = 1}^{j} \frac{{a}_{ij}^{2}}{{q}_{j}^{i}} 1 ) + {n}_{i + 1} ( {\sum }_{j = 1}^{j} \frac{{a}_{i + 1 , j}^{2}}{{q}_{j}^{1}} 1 ) \qquad ( 3 )$$

i.e., also following transformation:

$${x}_{1 , i + 1}^{2} = \frac{{n}_{i} {n}_{i + 1}}{{n}_{i} + {n}_{i + 1}} {\sum }_{j - 1}^{j} \frac{{( {a}_{ij} - {a}_{i + 1 , j} )}^{2}}{{q}_{j}^{1}} \qquad ( 4 )$$

Π²_{[illeg.]} is a random variable following a law for Π² with J−1 degrees of freedom. The ChiMerge method proposes that rows i and i+1 be merged if:

prob(Π²_{[illeg.]}J−1)#p_{Th} (5)

where prob(∀,K) indicates the probability that Π²≧∀ for the law of Π² with K degrees of freedom, and p_{Th} is a predetermined threshold value defining the method parameter. In practice, the value prob(∀,K) is obtained from a standard Π² table, giving the value of ∀ as a function of prob(∀,K) and of K.

Condition (5) states that the probability of independence of S and T in light of the two rows considered falls beneath a threshold value. The merger of consecutive rows is iterative inasmuch as condition (5) is confirmed. The merger of two rows entails the regrouping of their modalities and a summing up of their counts. For example, in the case of a numerical attribute with continuous values, prior to merger we have:

TABLE 2

| | | | | | |
|---|---|---|---|---|---|
| [Sⱼ, Sⱼ j + 1[ | nⱼ, 1 | nⱼ + 1, 2 | . . . | nⱼ, I | nᵢ |
| [Sᵢ + 1, Sᵢ + 2[ | nᵢ + 1, 1 | nⱼ + 1, 2 | . . . | nⱼ + 1, J | nⱼ + 1 |

And after merger:

TABLE 3

| [Sᵢ, Sᵢ + 2[ | nᵢ, + nⱼ 1, 1 | nⱼ + 1, 2 + nᵢ + 1, 2 | . . . | nⱼ + nᵢ 1, J | nⱼ + nⱼ + |
|---|---|---|---|---|---|
| | | | | | 1 |

An initial problem arising from the use of the ChiMerge method is the choice of the parameter p_{Th}, which should not be too high due to the risk that all the rows will be merged, nor too low lest no pairs be merged. In practice, it is very hard to arrive at a compromise.

A second problem inherent to this method entails operating locally without taking into account the modalities set (or the number of intervals) for the source attribute. We do not know a priori if the results of discretization are optimal, in a global sense, for this set.

Moreover, the ChiMerge method is limited to a one-dimensional discretization, meaning that it can operate only on a single source attribute at a time, and not on a p-uplet of attributes.

Lastly, the ChiMerge method does not allow for measuring the probability of independence between a source and a target attribute, and consequently for a given target attribute, for classifying source attributes as a function of their probabilities of independence with regard to the target attribute.

The present invention relates to a method of attribute discretization without the drawbacks and limitations referred to above. Accordingly, the present invention is characterized by an attribute discretization method for a database containing a population of individuals, said attribute being a source attribute, which may take on various modalities. Said method is comprised of a first stage wherein said source attribute modalities are regrouped into elementary groups; a second stage wherein, based on a contingency table for a source and a target attribute, one can determine from among a set of pairs of elementary groups the pair of elementary groups whose merger most extensively reduces the probability of independence of the source and the target attribute; and a third stage wherein the pair of elementary groups thus determined is merged, said second and third stages being iterative inasmuch as there is one pair of elementary groups making it possible to reduce said probability of independence.

In order to determine the pair of elementary groups in the second stage, for each pair of elementary groups of said set an estimate can be made of the value of Π² in the contingency table following merger of said pair, selecting the pair producing the highest value of Π² after the merger.

Advantageously, for each pair of elementary groups the variance of Π² in the contingency table is calculated before and after said pair is merged. Variances ill Π² associated with the different pairs will then be selected in the form of a list of decreasing values, with the first pair on the list being selected.

Selection of the pair of elementary groups is followed by the merger of said pair if the probability of Π² relative to the contingency table after merger of said pair is lesser than the probability of Π² relative to the contingency table prior to merger.

In one variation, the probabilities of Π² relative to the contingency table before and after merger are expressed logarithmically.

Said set of elementary group pairs is typically comprised of all pairs of adjacent groups in the sense of a predetermined adjacency relationship.

By preference a search is made among the pairs of adjacent elementary groups for those comprising at least one group with at least one theoretical count per contingency table cell that is lower than a predetermined minimum count, which are identified as priority pairs using identification data. In such a case, if there are one or more priority pairs, a merger is performed on the priority pair producing the highest value of Π² following merger.

In one embodiment, when the source attribute is a one-dimensional numerical attribute, adjacent elementary groups are comprised of adjacent intervals.

In a second embodiment, when the source attribute is a multi-dimensional numerical attribute formed of various one-dimensional numerical attributes, and individuals in the population are represented by points in the space of said attributes, said elementary groups are Voronoi cells in this space, containing said points.

In such case, a Delaunay graph associated with the Voronoi cells is constructed, with all arcs that join two adjacent cells passing through a third being eliminated from the graph, with the pairs of adjacent elementary groups now being given by the arcs on the Delaunay graph following said elimination.

In a third embodiment, the source attribute is of a symbolic type.

The present invention also relates to a method for evaluating the dependence of a two-dimensional numerical attribute formed by a pair of one-dimensional numerical attributes relative to a target attribute. Individuals in the population are represented by points in the plane of said attributes. In accordance with this method, the two-dimensional attribute is discretized by the multi-dimensional discretization method referred to above, which is displayed by display methods for groups of Voronoi cells merged by said method.

Lastly, the present invention relates to data mining software comprised of a discretization program with at least one database attribute, so that when it is run on a computer it performs the stages of the method referred to above.

Characteristics of the present invention referred to above, in addition to others, will become more evident upon reading the following description of one embodiment, said description pertaining to the attached drawings, including the following:

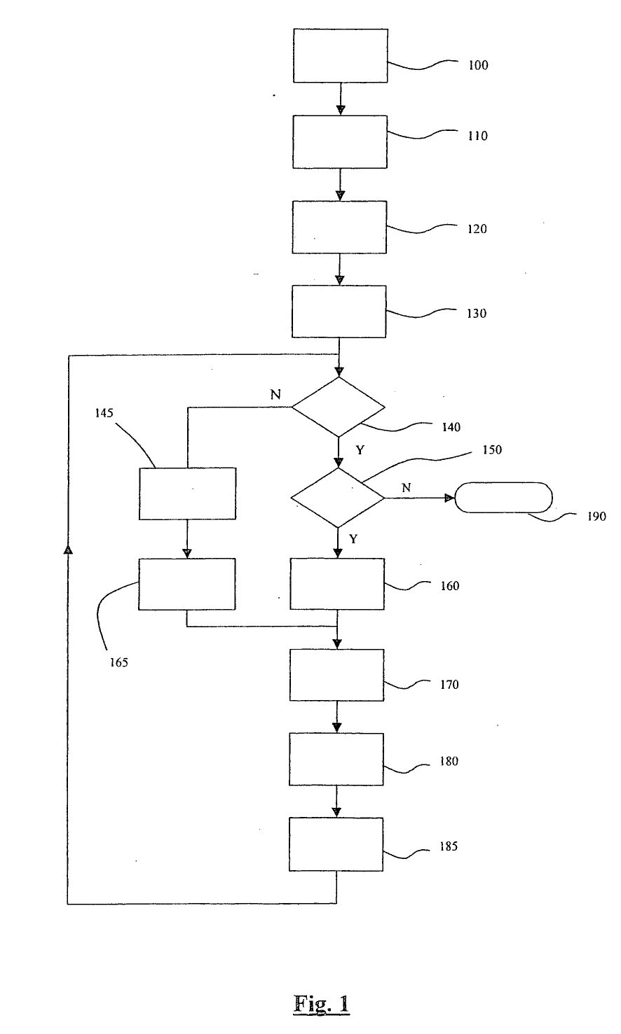

FIG. 1 is an organizational chart illustrating the method for discretization of attributes in one embodiment of the present invention;

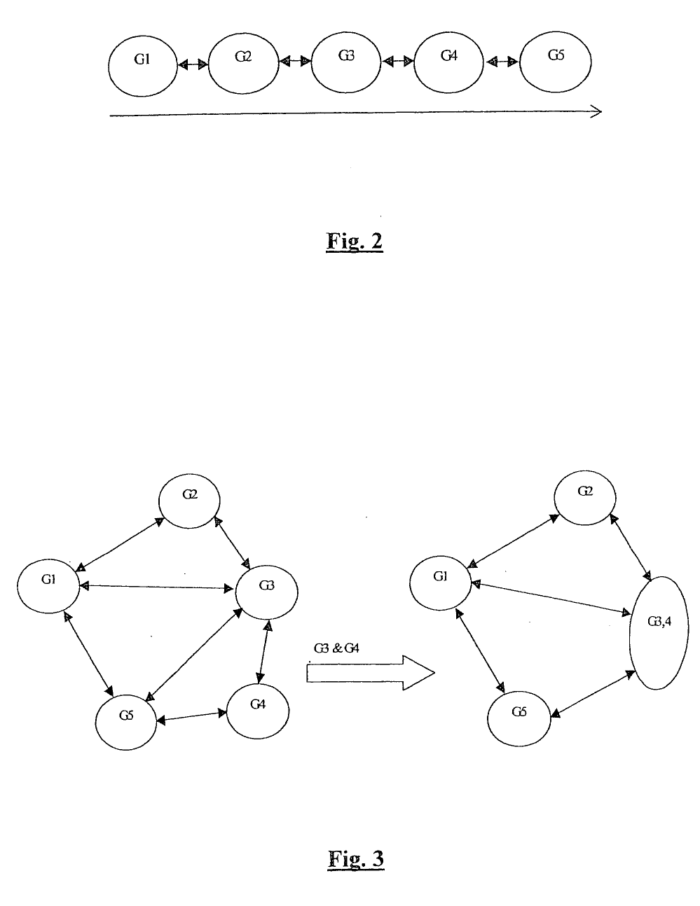

FIG. 2 illustrates an initial example of the discretization of a symbolic attribute;

FIG. 3 illustrates another example of the discretization of a symbolic attribute before and after merger;

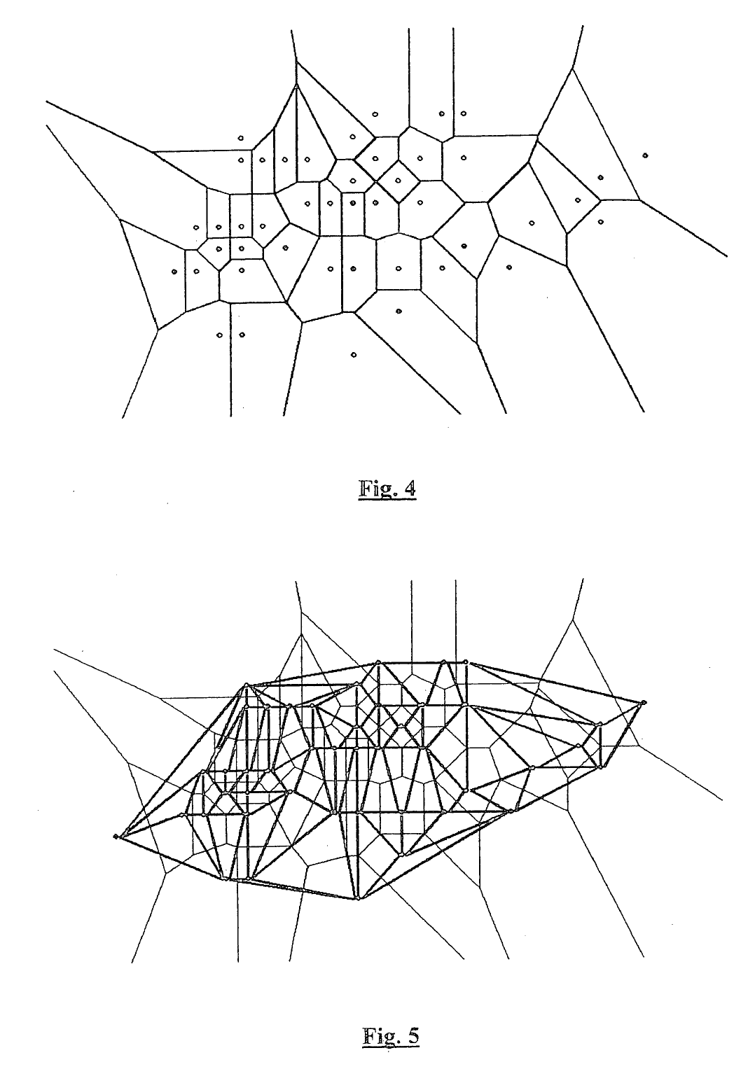

FIG. 4 is an example of a Voronoi graph;

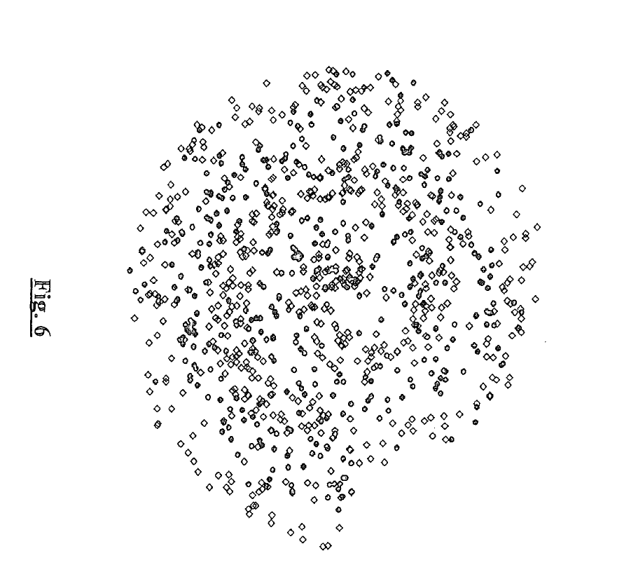

FIG. 5 is the Delaunay graph associated with the Voronoi graph of FIG. 4;

FIG. 6 is a set of individuals projected onto the plane of two numerical attributes;

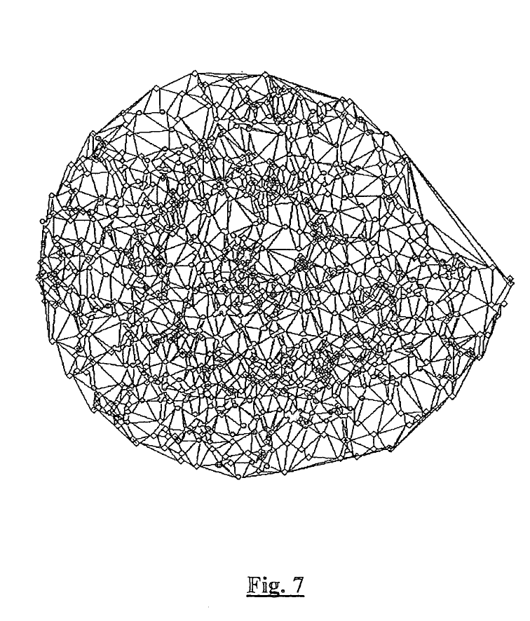

FIG. 7 is the Delaunay graph associated with the set of individuals in FIG. 6;

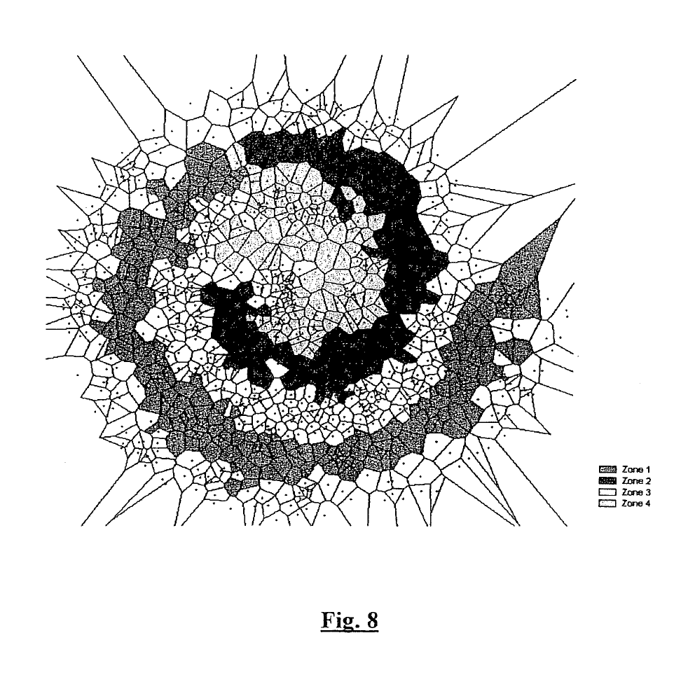

FIG. 8 is the discretization zones associated with the set of individuals in FIG. 5.

An initial general idea based on the present invention entails the discretization of a source attribute by optimizing statistical criteria applied to the contingency table set. A second general idea based on the present invention entails extrapolating this discretization to a multi-dimensional case by using a Delaunay graph.

We will first describe the present invention in the case of a one-dimensional numerical attribute S with continuous values. After having ordered the S modalities, the set of these modalities can be partitioned into elementary intervals S=[sᵢ,sᵢ+1[,i=1, J. We want to evaluate the degree of independence of this attribute with target attribute T with modalities T₁j=1, . . . J. These T₁ modalities can be symbolic or numerical. In the latter instance, they may be discrete values or intervals with continuous values. The contingency table is as follows:

TABLE 4

| S/T | T₁ | T₂ | . . . | Tⱼ | Total |
|---|---|---|---|---|---|
| S₁ | n₁, 1 | n₁, 2 | . . . | n₁, 3 | n_{[illeg.]} |
| . . . | . . . | . . . | . . . | . . . | . . . |
| S₁ | n₁, 1 | n₁, 2 | . . . | n_{[illeg.]} | n_{[illeg.]} |
| S₁ + 1 | n₁, [illegible] | n₁ + 1, 2 | . . . | n_{[illeg.]} | n_{[illeg.]} |
| . . . | . . . | . . . | . . . | . . . | . . . |
| S₁ | n₁, 2 | n₁, 2 | . . . | n_{[illeg.]} | n_{[illeg.]} |
| Total | n₁ | n₂ | . . . | n_{[illeg.]} | N |

In accordance with (1), the value of Π² for the table set can be expressed by:

$${x}^{2} = {\sum }_{i = 1}^{i} {\sum }_{j = 1}^{j} \frac{{( {n}_{y} - {e}_{y} )}^{2}}{{e}_{y}} \qquad ( 6 )$$

Further noting q₁, q₂ . . . q_{[illeg.]}, probability distribution for the target attribute modalities and ∀_{[illeg.]}, the proportions of counts observed for row i and noting that e_{[illeg.]}=q_{[illeg.]}n_{[illeg.]}n_{[illeg.]}=∀_{[illeg.]}

$${n}_{[ illeg . ]} and {\sum }_{j = 1}^{j} {q}_{j} {\sum }_{j = 1}^{j} {a}_{j} = 1 \text{:}$$

$${x}^{2} = {\sum }_{j = 1}^{j} {n}_{i} {\sum }_{j - 1}^{j} ( \frac{{a}_{y}^{2}}{{q}_{1}} 1 ) = {\sum }_{1 = i}^{1} {x}_{( i )}^{2} \qquad ( 7 )$$

where Π²_{[illeg.]} is the value of Π² for row i. The formula (7) means that Π² is additive with regard to the rows of the table.

Let us now suppose that two consecutive rows i and i+1 are merged. The value of Π² following merger, or Π²_{[illeg.]}, can be written as:

$${x}_{f ( i , i = 1 )}^{2} = {\sum }_{[ illegible ]} {x}_{( k )}^{2} + {x}_{[ illeg . ] + 1}^{2} + {\sum }_{[ illeg . ] + 1} {x}_{( k )}^{2} \qquad ( 8 )$$

where Π²_{[illeg.]} is the value of Π² for the row produced by the merger, or:

$${x}_{[ illeg . ] + 1}^{2} = ( {n}_{i} + {n}_{i - 1} ) {\sum }_{j - 1}^{j} ( \frac{{a}_{y}^{{1}^{2}}}{{q}_{j}} ) with {a}_{y}^{1} = \frac{{n}_{y} + {n}_{i + 1 , j}}{{n}_{i} + {n}_{i + 1}} \qquad ( 9 )$$

The formula (8) can be expressed simply as a function of the value of Π² before merger:

xⱼ₍ᵢⱼ₊₁₎²=x²+x²₍ᵢⱼ₊₁₎−x²₍ᵢ₎x²₍ᵢ₋₁₎=x²+Δx²₍ᵢⱼ₊₁₎ (10)

where [illegible] is the variation of Π² resulting from the merger of rows i and i+1. The value of )Π² _{[illeg.]} may be explicitly calculated as a function of the proportions of the counts for rows i and i+1:

$$Δ {x}_{( ij + 1 )}^{2} = - ( \frac{{n}_{y} + {n}_{i + 1 , j}}{{n}_{i} + {n}_{i + 1}} ) {\sum }_{j - 1}^{j} \frac{{( {a}_{y} - {a}_{i + 1 , j} )}^{2}}{{q}_{1}} \qquad ( 11 )$$

The list of values of )Π²_{[illeg.]} is arranged by decreasing value, with )Π²_{[illeg.]} the first element on the list. Thus we test as to whether:

prob(x²_{[illeg.]}(I−2)(J−1) )≦prob(x²_{[illeg.]}(I−2)(J−1)) (12)

It can be seen that the law of Π² for the first term has only (J−2)(J−1) degrees of freedom after merger. In practice, owing to the low values that the terms of (12) may assume, the comparison will advantageously entail the logarithms of these probabilities.

Condition (12) results in a decreased probability of independence for S and T following merger of rows i_{[ileg.]} and i_{[illeg.]}. Given the negative value )Π²_{[illeg.]}, the value of Π² can only decrease after merger. Given that prob(∀,K) is a decreasing function of ∀ and an increasing function of K, the relationship (12) can be confirmed only on the basis of the decreasing number of degrees of freedom. The decrease in the independence probability will be all the more important since )Π²_{[illeg.]} will be a low absolute value, in other words, in accordance with the relationship (11) whereby the proportions observed for the rows considered will be closer, this being for the weakest proportions q1.

If condition (12) is confirmed, rows iₒ and iₒ+1 are merged. On the other hand, if condition (12) is not confirmed, then it is not confirmed by any index i following the decrease of prob(∀,K) as a function of ∀. Accordingly, the merger process is halted.

If rows iₒ and iₒ+1 have been merged, the list of Values )Π²_{[illeg]} is updated. It will be noted that this updating in fact involves only values for rows adjacent to the merged rows, i.e., index rows iₒ−1 and iₒ+2 prior to merger (if they exist). The merger process is iterative as long as condition (12) is satisfied.

The method described above leads to an ad hoc discretization of the modality domain, i.e., a discretization that minimizes the independence between the source and the target attribute for the domain set. The discretization method makes it possible to regroup adjacent intervals whose prediction behavior is similar with regard to the target attribute, with regrouping halted whenever it has a negative effect on the quality of prediction, or in other words, whenever it no longer decreases the probability of independence of attributes.

A contingency table is obtained by successive mergers, one with a reduced number of rows and whose count per cell increases. So as to be able to draw reliable conclusions relative to the dependence or independence of the source and target attributes, it is desirable to have a minimum count per cell. It is commonly accepted that the Π² test is reliable for theoretical counts higher than 5 per cell. Even more so, with a nonhomogenous distribution being more probable for a low population than for a higher one, for low values of theoretical counts e_{[illeg.]} a phenomenon known as “over-learning” can be noted, which, based on a high Π² value, can lead to an erroneous conclusion of a dependence of attributes. It is therefore advisable to adhere to a minimum theoretical count per cell. It can be shown that with a minimum average count of around log₂(10N) (where N is the total number of individuals) per cell, an erroneous conclusion of a dependence of attributes can be avoided. Thus the discretization method is adapted as follows: first, priority is given to mergers of confirmation rows (12) making it possible to confirm a minimum count criterion. This criterion may be written, for example, for the row l_{g}:

e_{[illeg.]})log₂(10N)_{[illeg.]}j=1[illegible] (13)

To do this, row pairs at least one of which does not confirm the condition of minimum count (13) can be flagged, with the first pair of flagged index rows iₑ and iₑ+1 being merged. After merging, the flags of adjacent rows i_{g}−1 and i_{g}+2 are updated based on the count reached by the merged row. When every row has reached the minimum count, only condition (12) is taken into consideration since the minimum count criterion has been met.

FIG. 1 illustrates the algorithm of one example of a discretization method according to the present invention.

The algorithm begins with a partitioning stage 100 for the domain of values of the source law in ordered elementary intervals. The value of Π² for the contingency table and the values Π²₁₀ for the J rows of the table are calculated at 110. The )Π²_{[illeg.]} values are then subtracted from the ). Π²_{[illeg.]} values at stage 120 and arranged by decreasing values in listed form at 130. Each element of the list corresponds to the possible merger of a pair of rows i and i+1. Stage 140 tests whether the minimum count condition (13) has been confirmed. If it has, one goes directly to test 150. If not, one continues with test 145.

At stage 145, priority (at least for flagging) is given to row pairs at least one of which has not reached the minimum count, with the first priority pair on the list selected at 165, indicated as (i_{g}, i_{g}+1). The process continues at 170.

At stage 150 a test is performed as to whether the first element on the list confirms condition (12). If it does not, the process is halted at 190. If, however, there is confirmation, the first pair on the list is selected at 160, which is also indicated (iₒ, iₒ+1), and we continue with stage 170.

At stage 170, rows iₒ, iₒ+1 of the selected pair are merged, i.e., the intervals Sᵢ and Sᵢ+1 are concatenated. The new value of Π²_{[illeg.]} is then calculated at 180, as well as the new values of )Π²_{[illeg.]} and )Π²_{[illeg.]} for the adjacent intervals, if such exist. At 185, the list of values of )Π²_{[illeg.]} is updated: the former values )Π²_{[illeg.]} and )Π²_{[illeg.]} are eliminated and the new values stored. The list of values )Π²_{[illeg.]} is advantageously organized in the form of a balanced binary search tree whereby the insertions/eliminations can be generated while maintaining the ordered relationship in the list. Accordingly, it is not necessary to arrange the list fully at each stage. The flagged list is also updated. After updating, the process returns to test stage 140.

In one embodiment, the list is comprised of (positive) values Π²_{[illeg.]} rather than of (negative) values )²_{[illeg.]}.

Upon concluding the discretization process, we have the Π² value of the discretized attribute. Accordingly, if we proceed to the discretization of a number of source attributes S_{[illeg.]}, we can compare their predicting ability with regard to the target attribute by comparing the probabilities prob(Π²_{[illeg.]}, ∀_{[illeg.]} where the Π²_{[illeg.]} and ∀_{[illeg.]} are values of Π² and the respective degrees of freedom for the discretized attributes.

We have so far assumed that the attribute S was one-dimensional numerical with continuous values. The discretization method described above is still applicable when S has discrete numerical values. The numerical modalities are first ordered to form rows in the contingency table for S and T, then regrouped by elementary group, with one elementary group containing only one element, as needed. The discretization method operates in accordance with the same principle as before, by merging the elementary groups as long as the probability of independence of S and T decreases.

The discretization method may still operate on symbolic attributes, with the difference that there is not necessarily a relationship of total order among the attribute modalities. If there is such an order relationship, we can revert to the preceding case by ordering the modalities according to this order relationship. FIG. 2 illustrates this situation: individuals are regrouped into elementary groups G₁, G₂ . . . Gᵢ, with each group containing the individuals relative to a modality or an interval of modalities (in the sense of the aforesaid order relationship). The groups are equivalent to the contingency table rows. They can be ordered on a linear graph, with each node corresponding to a group. Merger can be performed only according to the arcs of this graph, between adjacent groups. On the other hand, if the set of source attribute modalities does not have a total order relationship, we can nevertheless define the adjacency relationships by the arcs of a graph, as seen on the left-hand side of FIG. 3. The arcs indicate possible mergers between the groups. After two groups have been merged, the arcs of the graphs are reorganized. The right-hand side of FIG. 3 shows a reorganization of the graph following merger of groups 3 and 4. Here the discretization method operates on the nodes of the graph in the same way as it previously did on the contingency table rows.

Functioning of the discretization method will be illustrated by using an example of a database containing attributes of flowers in the Iris family. The database population used is 150 individuals. We have considered the “sepal width” source attribute, and the flower class target attribute: Iris setosa, Iris versicolor and Iris virginica. In this example, the source attribute is a numerical attribute with continuous values, and the target attribute is a symbolic attribute with 3 modalities. The contingency table is as follows:

TABLE 5

| | Iris | Iris | Iris | |
|---|---|---|---|---|
| Sepal width | versicolor | virginica | setosa | Total |
| 2 | 1 | 0 | 0 | 1 |
| 2.2 | 2 | 1 | 0 | 3 |
| 2.3 | 3 | 0 | 1 | 4 |
| 2.4 | 3 | 0 | 0 | 3 |
| 2.5 | 4 | 4 | 0 | 8 |
| 2.6 | 3 | 2 | 0 | 5 |
| 2.7 | 5 | 4 | 0 | 0 |
| 2.8 | 6 | 8 | 0 | 14 |
| 2.9 | 7 | 2 | 1 | 10 |
| 3 | 8 | 12 | 6 | 26 |
| 3.1 | 3 | 4 | 5 | 12 |
| 3.2 | 3 | 5 | 5 | 13 |
| 3.3 | 1 | 3 | 2 | 6 |
| 3.4 | 1 | 2 | 9 | 12 |
| 3.5 | 0 | 0 | 6 | 6 |
| 3.6 | 0 | 1 | 2 | 3 |
| 3.7 | 0 | 0 | 3 | 3 |
| 3.8 | 0 | 2 | 4 | 6 |
| 3.9 | 0 | 0 | 2 | 2 |
| 4 | 0 | 0 | 1 | 1 |
| 4.1 | 0 | 0 | 1 | 1 |
| 4.2 | 0 | 0 | 1 | 1 |
| 4.4 | 0 | 0 | 1 | 1 |
| Total | 50 | 50 | 50 | 130 |

During initializing, the domain of the sepal width modalities is partitioned [0_{[illeg.]}+∞[in 23 elementary intervals:]−∞; 2.1],]2.1;2.25] . . . ]4.15; 4.3],4,3; +∞[. The value of Π² is 88.36. Taking the corresponding law of Π² at 44 degrees of freedom, or (44=(23−1)*(3−1)), we obtain a probability of independence of 8.3 10⁻⁵. As shown in Table 6, we therefore calculate the Π² resulting from each merger of intervals: Π²_{[illeg.]}. For example, the merger of intervals ]−∞; 2.1],]2.1; 2.25] gives a new interval]−∞; 2.25] and the Π² resulting from the new table drops to 87.86.

TABLE 6

| Merged interval | Π²_{[illeg.]} |
|---|---|
| ]∞2.25] | 87.86 |
| ]2.10; 2.35] | 87.44 |
| ]2.25; 2.45] | 87.72 |
| ]2.35; 2.55] | 85.09 |
| ]2.45; 2.65] | 88.18 |
| ]2.55; 2.75] | 88.33 |
| ]2.65; 2.85] | 87.83 |
| ]2.75; 2.95] | 84.49 |
| ]2.85; 3.05] | 83.18 |
| ]2.95; 3.15] | 87.03 |
| ]3.05; 3.25] | 88.29 |
| ]3.15; 3.35] | 88.12 |
| ]3.25; 3.45] | 86.86 |
| ]3.35; 3.55] | 87.20 |
| ]3.45; 3.65] | 87.03 |
| ]3.55; 3.75] | 87.36 |
| ]3.65; 3.85] | 87.03 |
| ]3.75; 3.95] | 87.36 |
| ]3.85; 4.05] | 88.36 |
| ]3.95; 4.15] | 88.36 |
| ]4.05; 4.25] | 88.36 |
| ]4.15; +∞] | 88.36 |

We now seek a merger that will maximize the Π² law, with the maximum value of Π² arising from a merger being 88.36, attained for example by merging the last two intervals ]4.15, 4.3] and ]4.3 +∞[. By taking the corresponding law of Π² at 42 degrees of freedom (with one less interval), we obtain a probability of independence of 3.8 10⁻⁵. With a decreased probability of independence, discretization is improved and the corresponding merger is performed. Since discretization has been improved, we can once again begin these stages. Table 7 illustrates the successive stages of discretization. Bold-faced figures mean that the minimum count has been reached, in the sense of the relationship (13). In this case, inasmuch as the target attribute modalities are equally divided (q₁=q₂=q₃), the relationship (13) is equal to a theoretical count per row of 33 (3 log₂)(10*150)). When this count is reached for every row, the criterion of minimum count is no longer considered.

TABLE 7

| Sepal | Iris | Iris | Iris | | | | | | | |
|---|---|---|---|---|---|---|---|---|---|---|
| width | versicolor | virginica | setosa | Total | | | | | | |
| 2 | 1 | 0 | 0 | 1 | 3-1-0 | 9-1-1 | | | | 34-21-2 |
| 2.2 | 2 | 1 | 0 | 3 | | | | | | |
| 2.3 | 3 | 0 | 1 | 4 | 6-0-1 | | | | | |
| 2.4 | 3 | 0 | 0 | 3 | | | 12-10-0 | 18-18-0 | 25-20-1 | |
| 2.5 | 4 | 4 | 0 | 8 | 8-5-0 | | | | | |
| 2.6 | 3 | 2 | 0 | 5 | | | | | | |
| 2.7 | 5 | 4 | 0 | 9 | | | | | | |
| 2.8 | 6 | 8 | 0 | 14 | | | | | | |
| 2.9 | 7 | 2 | 1 | 10 | | | | | | |
| 3 | 8 | 12 | 6 | 26 | | | | 15-24-18 | | |
| 3.1 | 3 | 4 | 5 | 12 | 6-9-10 | 7-12-12 | | | | |
| 3.2 | 3 | 5 | 5 | 13 | | | | | | |
| 3.3 | 1 | 3 | 2 | 6 | | | | | | |
| 3.4 | 1 | 2 | 9 | 12 | 1-2-15 | | 1-5-24 | 2-5-30 | | |
| 3.5 | 0 | 0 | 6 | 6 | | | | | | |
| 3.6 | 0 | 1 | 2 | 3 | 0-1-5 | 0-3-9 | | | | |
| 3.7 | 0 | 0 | 3 | 3 | | | | | | |
| 3.8 | 0 | 2 | 4 | 6 | | | | | | |
| 3.9 | 0 | 0 | 2 | 2 | | | | 0-0-6 | | |
| 4 | 0 | 0 | 1 | 1 | 0-0-2 | 0-0-4 | | | | |
| 4.1 | 0 | 0 | 1 | 1 | | | | | | |
| 4.2 | 0 | 0 | 1 | 1 | 0-0-2 | | | | | |
| 4.4 | 0 | 0 | 1 | 1 | | | | | | |
| Total | 50 | 50 | 50 | 150 | | | | | | |

At the conclusion of twenty stages, we arrive at the following discretized law:

TABLE 8

| Sepal | Iris | Iris | Iris | |
|---|---|---|---|---|
| width | versicolor | virginica | setosa | Total |
| ]−∞; 2.95[ | 34 | 21 | 2 | 57 |
| [2.95; 3.35] | 15 | 24 | 18 | 57 |
| [3.35; ∞] | 1 | 5 | 30 | 36 |
| total | 59 | 50 | 50 | 150 |

The value of Π² associated with the discretized law is 70.74, corresponding to a probability of independence of 1.66 10⁻¹⁴ (law of Π² with 4 degrees of freedom). Two interval mergers are still possible, with the best being the first, corresponding to a Π² with a value of 54.17. The related probability of independence is 1.73 10⁻¹² (law of Π² with 2 degrees of freedom), a merger that fails to meet condition (12), in that it increases the probability of independence, and is therefore rejected.

The “sepal width” attribute has been discretized in 3 intervals. In the first, the class Iris setosa is extremely rare. In the second, there is a balance between the three classes, and in the last one, the class Iris setosa is by far the most frequent. This division is the one that minimizes the probability of independence of the “sepal width” and “flower class” attributes.

We will now study the case wherein the attribute to be discretized is multi-dimensional, i.e., where the attribute can be expressed as a vector S=(S¹, . . . S⁰), where D is the attribute dimension and S^{d}, d=1, . . . ,D are one-dimensional attributes. To simplify the issue, we will consider a two-dimensional numerical attribute (D=2). Thus each individual can be represented as a point whose coordinates are the S¹ and S² modalities of the individual. The population of N individuals in the database can therefore be “projected” in a plane (S¹, S²) in the form of a set of points ε. The adjacency relationships between these points can be displayed using a Voronoi diagram for the set ε. It will be recalled that the Voronoi diagram associated with a set ε of points is a division of space (a plane in this instance) into cells each of which contains a point of ε, with each cell defined as the set of points in the space that are closer to a given point in ε than all the other points in ε. A cell is formed by a convex polyhedron (a polygon in this instance) surrounding a point in ε, each face of the polyhedron being a mediator plane for the point in ε associated with the cell and an adjacent point. By way of example, a Voronoi diagram associated with a set of points is represented in FIG. 4. Based on the Voronoi diagram, we can construct a dual diagram, known as a Delaunay diagram, connecting the points in ε pertaining to the adjacent cells. FIG. 5 illustrates the Delaunay diagram (or graph) associated with the Voronoi diagram in FIG. 4. Each arc of the Delaunay graph represents an adjacency relationship between two points in ε.

The discretization method constructs the Delaunay graph for ε and uses the arcs from this graph to partition the space into elementary zones. More specifically, the graph is comprised of direct and indirect arcs. Direct arcs between two nodes only pass through the two adjacent cells associated with these nodes. Along a direct arc, the closest adjacent one is always one of the two points of the two adjacent cells. Indirect arcs past through at least a third Voronoi cell. Along an indirect arc, the closest adjacent one may be a third point that pertains to neither of the two adjacent cells. During pretreatment, the indirect arcs are eliminated. Only the direct arcs resulting in a direct adjacency relationship are taken into consideration while the discretization method is being initialized. Merger of the Voronoi cells based on the direct arcs of the Delaunay graph provides the elementary zones.

After the space in elementary zones has been partitioned, the discretization method operates iteratively by the merging of zones, with the only authorized mergers being those indicated by a (direct) arc in the Delaunay graph. As in the one-dimensional case, merger of two zones is performed only if condition (12) has been confirmed, i.e., if this merger results in a decreased probability of independence for the S and T attributes. Discretization produces connected regions, each of which is in fact a connected joining of Voronoi cells. Each region regroups statistically homogenous individuals by means of the target attribute; otherwise, the behavior of two different regions varies with regard to this attribute.

Moreover, as in the one-dimensional case, the value of probability of independence obtained from discretization allows for a comparison of pairs (generally speaking n-uplets) of continuous attributes, and for classifying them as a function of their prediction value for a target attribute.

The multi-dimensional discretization method is also applied to a multi-dimensional symbolic attribute, i.e., an attribute S=(S¹, . . . S⁰) where S^{d} are symbolic attributes. As in the one-dimensional case, a graph is constructed whose nodes are modalities or groups of modalities, with arcs used to indicate possible mergers among groups.

By way of example, FIG. 6 illustrates a population of individuals in a database projected onto the plane defined by two continuous numerical attributes. The target attribute is the class of individuals that may take on the “class 1” modality, represented by a diamond, or the “class 2” modality, represented by a point.

FIG. 7 is the associated Delaunay diagram. It will be recalled that only the direct arcs from this diagram will be retained to initialize the list of possible mergers.

The discretization method as described above results in four zones, indicated in FIG. 8 by varying shades of gray. These connected zones are formed by the merger of Voronoi cells each of which contains an individual from the initial population. Discretization makes it possible to visualize the behavior of the numerical attribute pair with regard to the target attribute. In the example given, one can observe a spiral dependence relationship between the attribute pair and the target attribute. The contingency table is as follows:

TABLE 9

| | Class 1 | Class 2 | Count |
|---|---|---|---|
| Zone 1 | 11.8% | 88.2% | 212 |
| Zone 2 | 2.5% | 97.5% | 122 |
| Zone 3 | 88.7% | 11.3% | 512 |
| Zone 4 | 69.5% | 30.5% | 154 |

Accordingly, Zones 1 and 2 are by far comprised of Class 2 individuals, while Zone 3 basically consists of Class 1 individuals.

1. A discretization method for a database attribute containing a population of individuals, said attribute, known as the source attribute, capable of assuming several modalities, wherein in an initial stage said source attribute modalities are regrouped into elementary groups and wherein a source and a target attribute contingency table is used in a second stage to determine from among a set of elementary group pairs the pair of elementary groups whose merger most extensively decreases the probability of independence of the source and the target attribute, and wherein in a third stage the pair of elementary groups thus determined is merged, said second and third stages being iterative in as much as there is a pair of elementary groups allowing for said probability of independence to be decreased.

2. The discretization method of claim 1, wherein to determine the pair of elementary groups in the second stage an estimate is made of the value of Π² in the contingency table for each pair of elementary groups of said set after merging said pair, and the pair producing the highest value of Π² after merger is selected.

3. The discretization method of claim 2, wherein for each pair of elementary groups, a calculation is made of the variation of Π² in the contingency table before and after merger of said pair.

4. The discretization method of claim 3, wherein variations of Π² associated with the different pairs are arranged in the form of a list of decreasing values and the first pair on the list is selected.

5. The discretization method of any one of claims 2 to 4, wherein after selecting the pair of elementary groups, merger of said pair is then performed if the probability of Π² relative to the contingency table after merger of said pair is less than the probability of Π² relative to the contingency table before merger.

6. The discretization method of claim 5, wherein the probabilities of Π² relative to the contingency table before and after merger are expressed logarithmically.

7. The discretization method of any one of the previous claims, wherein said set of elementary group pairs is comprised of all pairs of adjacent groups in the sense of a predetermined adjacency relationship.

8. The discretization method of claim 7, wherein among the pairs of adjacent elementary groups one searches for those comprising at least one group presenting at least one theoretical count per contingency table cell less than a predetermined minimum count and they are identified as priority pairs by means of identification data.

9. The discretization method of claim 8, wherein if there are one or more priority pairs, the priority pair producing the highest value of Π² after merger is selected.

10. The discretization method of any one of claims 7 to 10 [sic], wherein when the source attribute is a one-dimensional numerical attribute the adjacent elementary groups are comprised of adjacent intervals.

11. The discretization method of any one of claims 7 to 10, wherein when the source attribute is a multi-dimensional numerical attribute formed by multiple one-dimensional and numerical attributes and the individuals of the population are represented by points in space of said attributes, said elementary groups are Voronoi cells of said space containing said points.

12. The discretization method of claim 11, wherein the Delaunay graph associated with the Voronoi cells is constructed and all arcs linking two adjacent cells by passing through a third are eliminated, with the pairs of elementary groups now given by the arcs of said Delaunay graph following the elimination stage.

13. The discretization method of any one of claims 7 to 10, wherein the source attribute is of a symbolic type.

14. A method for evaluating the dependence of a database attribute with regard to a target attribute, wherein said attribute is discretized by the discretization method according to any one of claims 1 to 13 and the dependence of said attributed is estimated on the basis on the probability of the value of Π² for the attribute thus discretized.

15. A method for evaluating the dependence of a one-dimensional numerical attribute formed by a pair of one-dimensional numerical attributes with regard to a target attribute and with the individuals in the population represented by points in the plane of said attributes, wherein the one-dimensional attribute is discretized by the discretization method of claim 12 and wherein by visualization methods one can visualize groups of Voronoi cells merged by said method.

16. Data mining software comprising a discretization program for at least one database attribute, wherein when said program is run on a computer said program performs the stages of the method according to any one of the previous claims.
